(19) United States
(12) Patent Application Publication
(10) Pub. No.: US 2025/0136743 A1
(43) Pub. Date: May 1, 2025

(54) WATERBORNE POLYURETHANE AND PREPARATION METHOD THEREOF, AND WATERBORNE SCRATCH-OFF INK AND PREPARATION METHOD THEREOF

(71) Applicant: Langfang Andy New Material Company Limited, Langfang City (CN)

(72) Inventors: Shulin ZHANG, Langfang City (CN); Wangqing ZHANG, Langfang City (CN); Rongli YANG, Langfang City (CN); Liang ZHAO, Langfang City (CN); Yuhong SHI, Langfang City (CN)

(73) Assignee: Langfang Andy New Material Company Limited, Langfang City (CN)

(21) Appl. No.: 18/931,654

(22) Filed: Oct. 30, 2024

(30) Foreign Application Priority Data
Oct. 31, 2023 (CN) 202311422128.2

(51) Int. Cl. C08G 18/08; C08G 18/12; C08G 18/22; C08G 18/32; C08G 18/66; C09D 11/023; C09D 11/102

(52) U.S. Cl. CPC C08G 18/0804; C08G 18/0857; C08G 18/12; C08G 18/227; C08G 18/3228; C08G 18/6659; C08G 18/6692; C09D 11/023; C09D 11/102

(57) ABSTRACT

Provided are a waterborne polyurethane (WPU) and a preparation method thereof, and a waterborne scratch-off ink and a preparation method thereof. A chain end group or side group of the WPU contains a longer alkyl chain. When the WPU is used in the preparation of the waterborne scratch-off ink, microphase separation may occur during the film-forming process owing to a hydrophobic/hydrophilic interaction between the non-polar long-chain alkyl and polar groups in WPU molecular, resulting in an incomplete film structure, which is beneficial to make the ink be scratched off.

### CROSS REFERENCE TO RELATED APPLICATION

This patent application claims the benefit and priority of Chinese Patent Application No. 202311422128.2 filed with the China National Intellectual Property Administration on Oct. 31, 2023, the disclosure of which is incorporated by reference herein in its entirety as part of the present application.

### TECHNICAL FIELD

The present disclosure relates to the technical field of polymers, and particularly to a waterborne polyurethane and a preparation method thereof, and a waterborne scratch-off ink and a preparation method thereof.

### BACKGROUND

Scratch-off inks are widely used in production and life, such as printing lottery tickets, prize tickets, bills, phone recharge cards, game cards, Internet cards, lottery cards, learning cards, electronic code anti-counterfeiting identification cards, quick display books, and children's scratch paintings. The commonly used scratch-off inks are black scratch-off ink (abbreviated as black scratch-off) and white scratch-off ink (abbreviated as white scratch-off). A basic characteristic of these scratch-off inks lies in that after the ink is printed and dried to form an ink film, the ink film is more easily to be damaged by scratching. The above characteristic of scratch-off inks creates special requirements for film-forming resins or additives. Currently, the scratch-off inks on the market are mainly solvent-based inks. The volatilization of volatile organic compounds (VOCs) during the printing and harmful substances remaining in the printed products may cause harm to the environment and human health.

Chinese patent CN104419250A discloses a black waterborne scratch-off ink, which is prepared with a waterborne acrylic resin and a waterborne vinyl resin. However, a large amount of organic solvent is used in the black waterborne scratch-off ink, reaching not less than 7 wt %.

### SUMMARY

An object of the present disclosure is to provide a waterborne polyurethane (WPU) and a preparation method thereof, and a waterborne scratch-off ink and a preparation method thereof. In the present disclosure, the WPU can be used to prepare the waterborne scratch-off ink, reduce the dosage of organic solvent, and make the waterborne scratch-off ink have an organic solvent dosage of less than 2 wt %.

To achieve the above object, the present disclosure provides the following technical solutions:

The present disclosure provides a WPU, having a structure shown in formula I:

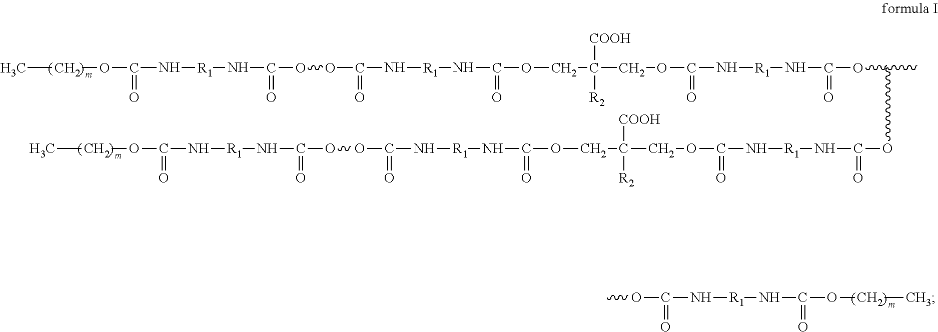

where in formula I, R₁ is selected from the group consisting of alkylene, cycloalkylene, and aralkylene; R₂ is selected from the group consisting of alkyl, cycloalkyl, and aralkyl; m is a natural number greater than or equal to 5; and wavy lines “ [symbol] ” represent a number of repeating units, and each of the repeating units has a structure shown in formula II:

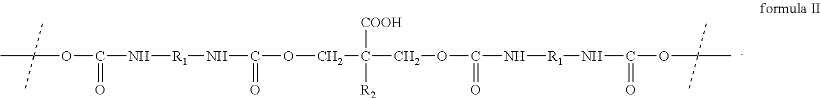

In some embodiments, in R₁, the alkylene comprises (is) one selected from the group consisting of C₁ alkylene to C₆ alkylene; the cycloalkylene comprises (is) one selected from the group consisting of C₅ cycloalkylene to C₁₅ cycloalkylene; and the aralkylene comprises (is) one selected from the group consisting of C₆ aralkylene to C₁₅ aralkylene; and
in R₂, the alkyl comprises (is) one selected from the group consisting of C₁ alkyl to C₆ alkyl; the cycloalkyl comprises (is) one selected from the group consisting of C₅ cycloalkyl to C₁₅ cycloalkyl; and the aralkyl comprises (is) one selected from the group consisting of C₆ aralkyl to C₁₅ aralkyl.

The present disclosure further provides a method for preparing the WPU, including the following steps:
(1) mixing a polymer polyol, a dihydroxymethyl carboxylic acid, a diisocyanate, and a catalyst to obtain a mixture; and subjecting the mixture to first-stage prepolymerization to obtain a first reaction system;
adding acetone into the first reaction system to adjust a viscosity of the first reaction system to 200 cP to 2,000 cP, and subjecting a resulting system to second-stage prepolymerization to obtain a first polyurethane prepolymer;
mixing the first polyurethane prepolymer and a long-chain aliphatic alcohol to obtain an admixture; and subjecting the admixture to end capping to obtain an end capping product; and
mixing the end capping product and a neutralizer under first stirring for 5 min to 10 min to obtain a second polyurethane prepolymer; where
the polymer polyol comprises one or more selected from the group consisting of a polyether polyol and a polyester diol;
the dihydroxymethyl carboxylic acid has a structural formula of (CH₂OH)₂—C(R₂)—COOH;
the diisocyanate has a structural formula of NCO—R₁—NCO; and
the long-chain aliphatic alcohol has a structural formula of CH₃—(CH₂)ₘ—OH; and
(2) mixing the second polyurethane prepolymer and water under second stirring for 1 min to 5 min to obtain a mixed system, the water being at a temperature of 2° C. to 10° C.;
adding an amine chain extender into the mixed system within 1 min to 5 min, and subjecting the mixed system and the amine chain extender to chain extension reaction under third stirring at ambient temperature for 0.5 h to 2 h; and
heating a resulting chain extension reaction product to a temperature of 40° C. to 50° C., and removing the acetone by distillation at the temperature and a pressure of 0.01 MPa to 0.09 MPa to obtain the waterborne polyurethane; where
the amine chain extender comprises at least one primary amino group; and the second stirring is conducted at a speed of 200 rpm to 1,000 rpm.

In some embodiments, the first-stage prepolymerization is conducted at a temperature of 70° C. to 90° C. for 1.5 h to 3 h;
the second-stage prepolymerization is conducted at a temperature of 70° C. to 90° C. for 1 h to 2 h; and
the end capping is conducted at a temperature of 70° C. to 90° C. for 2 h to 4 h.

In some embodiments, a ratio of an amount of substance of a hydroxyl group in the polymer polyol to an amount of substance of an isocyanate group in the diisocyanate is in a range of 0.1:1 to 0.3:1;
a ratio of an amount of substance of a hydroxyl group in the dihydroxymethyl carboxylic acid to the amount of substance of the isocyanate group in the diisocyanate is in a range of 0.2:1 to 0.3:1;
a ratio of an amount of substance of the long-chain aliphatic alcohol to the amount of substance of the isocyanate group in the diisocyanate is in a range of 0.2:1 to 0.3:1;
a ratio of an amount of substance of a primary amino group in the amine chain extender to the amount of substance of the isocyanate group in the diisocyanate is in a range of 0.2:1 to 0.3:1;
a ratio of an amount of substance of a sum of a total hydroxyl group in the polymer polyol, the dihydroxymethyl carboxylic acid, and the long-chain aliphatic alcohol and the primary amino group in the amine chain extender to the amount of substance of the isocyanate group in the diisocyanate is in a range of 0.90:1 to 0.98:1; and
a ratio of an amount of substance of the dihydroxymethyl carboxylic acid to an amount of substance of the neutralizer is in a range of 1:0.6 to 1:1.

In some embodiments, the water is added in such amount that the waterborne polyurethane has a solid content of 30 wt % to 50 wt %.

In some embodiments, the polyether polyol includes a polyether diol and a polyether triol; the polyether diol accounts for 80 wt % to 90 wt %, and the polyether triol accounts for 10 wt % to 20 wt %;
the polyester diol comprises (is) one or more selected from the group consisting of a polyester diol based on polyoxalic acid, a polyester diol based on polysuccinic acid, and a polyester diol based on polyadipic acid;
the dihydroxymethyl carboxylic acid comprises (is) one or two selected from the group consisting of 2,2-dihydroxymethyl propionic acid and dihydroxymethyl butyric acid;
the diisocyanate comprises (is) one or more selected from the group consisting of toluene diisocyanate, isophorone diisocyanate, hexamethylene diisocyanate, ethylphenyl diisocyanate, methylcyclohexyl diisocyanate, and trimethylhexyl diisocyanate;
the catalyst comprises (is) one or more selected from the group consisting of organic bismuth and organic tin;
the long-chain aliphatic alcohol comprises (is) one or more selected from the group consisting of n-hexanol, n-octanol, n-dodecanol, and n-octadecanol; and
the neutralizer comprises (is) one or two selected from the group consisting of triethylamine and triethanolamine.

In some embodiments, the amine chain extender comprises (is) one or more selected from the group consisting of ethylenediamine, propylenediamine, butylenediamine, 2-methylpentanediamine, hexamethylenediamine, isophoronediamine, and sodium 2-[(2-aminoethyl)amino]ethanesulphonate.

The present disclosure further provides a waterborne scratch-off ink, being prepared from raw materials comprising, in percentage by weight:
15% to 35% of a WPU, 0.1% to 1% of a bactericide, 10% to 20% of a filler, 0.1% to 1% of a defoamer, 15% to 50% of a color paste, 2% to 5% of a wax paste, 0.2% to 2% of a rheological agent, 1% to 2% of a film forming auxiliary, and 5% to 25% of water;
where the WPU is the WPU described above or a WPU prepared by the method described above.

The present disclosure further provides a method for preparing the waterborne scratch-off ink, including the following steps:
subjecting the waterborne polyurethane, the bactericide, the filler, and the defoamer to high-speed premixing;
subjecting a resulting premixture and the color paste to first low-speed mixing to obtain a colored mixture;
subjecting the colored mixture and the wax paste, the rheological agent, the film forming auxiliary, and the water to second low-speed mixing, and
regulating a pH value of a resulting mixed solution to 6 to 9 by using a pH regulator to obtain the waterborne scratch-off ink;
where the high-speed premixing is conducted at a speed of 200 rpm to 1,000 rpm; the first low-speed mixing is conducted at a speed of 50 rpm to 200 rpm; and the second low-speed mixing is conducted at a speed of 50 rpm to 200 rpm.

The present disclosure provides a WPU. In the present disclosure, a chain end group or side group of the WPU contains a longer alkyl chain. When the WPU is used in the preparation of the waterborne scratch-off ink, microphase separation may occur during the film-forming process owing to a hydrophobic/hydrophilic interaction between the non-polar long-chain alkyl and polar groups (such as carboxyl, carbamate) in WPU molecular, resulting in an incomplete film structure, which is beneficial to make the ink be scratched off. The above process of the present disclosure does not rely on solvents, and the WPU shows excellent emulsification, such that a dosage of the organic solvent in the WPU can be less than 2%, meeting the requirements of environmental protection.

The present disclosure further provides a method for preparing the WPU. In the present disclosure, the method has simple steps, convenient operation, and desirable operability.

The present disclosure further provides a waterborne scratch-off ink, where a WPU used is the WPU described above or the WPU prepared by the method described above. Owing to the hydrophobic/hydrophilic interaction between the non-polar long-chain alkyl and the polar groups (such as carboxyl, carbamate) in the WPU molecular, microphase separation may occur during the film-forming process, resulting in an incomplete film structure, which is beneficial to make the ink be scratched off. By adding the color paste, filler, and auxiliaries into the WPU, a white waterborne scratch-off ink or black waterborne scratch-off ink with low VOCs is prepared.

The present disclosure further provides a method for preparing the waterborne scratch-off ink. In the present disclosure, the method shows low cost and environmental friendliness, and can prepare black waterborne scratch-off ink and white waterborne scratch-off ink, showing a prospect of industrial application.

### DETAILED DESCRIPTION OF THE EMBODIMENTS

The present disclosure provides a WPU, having a structure shown in formula I:

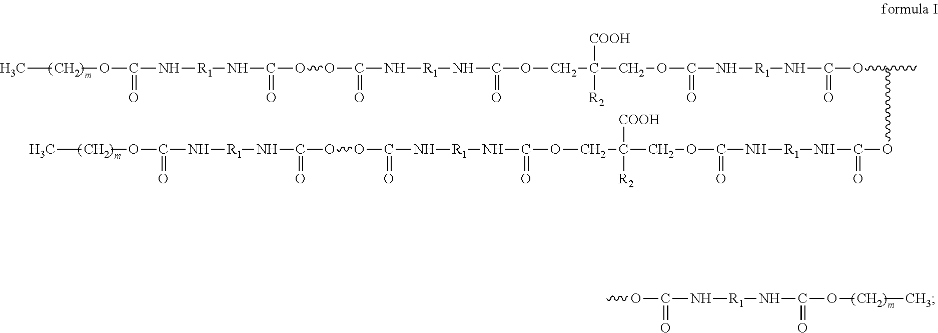

where in formula I, R₁ is selected from the group consisting of alkylene, cycloalkylene, and aralkylene; R₂ is selected from the group consisting of alkyl, cycloalkyl, and aralkyl; m is a natural number greater than or equal to 5; and wavy lines “ [symbol] ”, represent a number of repeating units, and each of the repeating units has a structure shown in formula II:

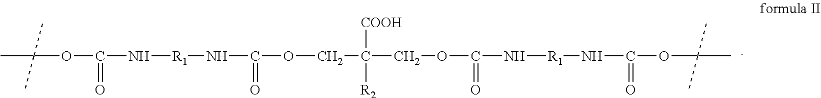

In the present disclosure, in some embodiments, in R₁, the alkylene includes one of C₁ alkylene to C₆ alkylene, preferably —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, or —CH₂—, and more preferably the —CH₂CH₂CH₂CH₂CH₂CH₂—.

In the present disclosure, in some embodiments, in R₁, the cycloalkylene includes one of C₅ cycloalkylene to C₁₅ cycloalkylene.

In the present disclosure, in some embodiments, in R₁, the aralkylene includes one of C₆ aralkylene to C₁₅ aralkylene.

In the present disclosure, in some embodiments, in R₂, the alkyl includes one of C₁ alkyl to C₆ alkyl, preferably-CH₃, —CH₂CH₃, —CH₂CH₂CH₃, —CH₂CH₂CH₂CH₃, —CH₂CH₂CH₂CH₂CH₃, or —CH₂CH₂CH₂CH₂CH₂CH₃, and more preferably the —CH₃ or the —CH₂CH₃.

In the present disclosure, in some embodiments, in R₂, the cycloalkyl includes one of C₅ cycloalkyl to C₁₅ cycloalkyl.

In the present disclosure, in some embodiments, in R₂, the aralkyl includes one of C₆ aralkyl to C₁₅ aralkyl.

In the present disclosure, m is a natural number greater than or equal to 5. In some embodiments, m is a natural number greater than or equal to 7; preferably a natural number greater than or equal to 10, and more preferably a natural number greater than or equal to 100.

The present disclosure further provides a method for preparing the WPU, including the following steps:
(1) mixing a polymer polyol, a dihydroxymethyl carboxylic acid, a diisocyanate, and a catalyst to obtain a mixture; and subjecting the mixture to first-stage prepolymerization to obtain a first reaction system;
adding acetone into the first reaction system to adjust a viscosity of the first reaction system to 200 cP to 2,000 cP, and subjecting a resulting system to second-stage prepolymerization to obtain a first polyurethane prepolymer;
mixing the first polyurethane prepolymer and a long-chain aliphatic alcohol to obtain an admixture; and subjecting the admixture to end capping to obtain an end capping product; and
mixing the end capping product and a neutralizer under first stirring for 5 min to 10 min to obtain a second polyurethane prepolymer; where
the polymer polyol comprises one or more selected from the group consisting of a polyether polyol and a polyester diol;
the dihydroxymethyl carboxylic acid has a structural formula of (CH₂OH)₂—C(R₂)—COOH;
the diisocyanate has a structural formula of NCO—R₁—NCO; and
the long-chain aliphatic alcohol has a structural formula of CH₃—(CH₂)ₘ—OH; and
(2) mixing the second polyurethane prepolymer and water under second stirring for 1 min to 5 min to obtain a mixed system, the water being at a temperature of 2° C. to 10° C.;
adding an amine chain extender into the mixed system within 1 min to 5 min, and subjecting the mixed system and the amine chain extender to chain extension reaction under third stirring at ambient temperature for 0.5 h to 2 h; and
heating a resulting chain extension reaction product to a temperature of 40° C. to 50° C., and removing the acetone by distillation at the temperature and a pressure of 0.01 MPa to 0.09 MPa to obtain the waterborne polyurethane; where
the amine chain extender comprises at least one primary amino group; and the second stirring is conducted at a speed of 200 rpm to 1,000 rpm.

In the present disclosure, a polymer polyol, a dihydroxymethyl carboxylic acid, a diisocyanate, and a catalyst are mixed (recorded as first mixing) to obtain a mixture; the mixture is subjected to first-stage prepolymerization to obtain a first reaction system; acetone is added into the first reaction to adjust a viscosity of the first reaction system to 200 cP to 2,000 cP; and a resulting system is subjected to second-stage prepolymerization to obtain a first polyurethane prepolymer. The first polyurethane prepolymer and a long-chain aliphatic alcohol are mixed (recorded as second mixing) to obtain an admixture; the admixture is subjected to end capping to obtain an end capping product; and the end capping product and a neutralizer are mixed under first stirring for 5 min to 10 min to obtain a second polyurethane prepolymer.

In the present disclosure, in some embodiments, a ratio of an amount of substance of a hydroxyl group in the polymer polyol to an amount of substance of an isocyanate group in the diisocyanate is in a range of 0.1:1 to 0.3:1, preferably 0.15:1 to 0.25:1, and more preferably 0.2:1.

In the present disclosure, in some embodiments, a ratio of an amount of substance of a hydroxyl group in the dihydroxymethyl carboxylic acid to the amount of substance of the isocyanate group in the diisocyanate is in a range of 0.2:1 to 0.3:1, preferably 0.22:1 to 0.28:1, and more preferably 0.24:1 to 0.26:1.

In the present disclosure, in some embodiments, a ratio of an amount of substance of the long-chain aliphatic alcohol to the amount of substance of isocyanate group in the diisocyanate is in a range of 0.2:1 to 0.3:1, preferably 0.22:1 to 0.28:1, and more preferably 0.24:1 to 0.26:1.

In the present disclosure, in some embodiments, the polyether polyol includes a polyether diol and a polyether triol. In some embodiments, the polyether diol accounts for 80 wt % to 90 wt %, and preferably 83 wt % to 87 wt %. In some embodiments, the polyether diol has a number average molecular weight of 1,000 Da to 3,000 Da, and preferably 2,000 Da. In some embodiments, the polyether triol accounts for 10 wt % to 20 wt %, and preferably 13 wt % to 17 wt %. In some embodiments, the polyether triol has a number average molecular weight of 1,000 Da to 3,000 Da, and preferably 2,000 Da.

In the present disclosure, in some embodiments, the polyester diol includes one or more selected from the group consisting of a polyester diol based on polyoxalic acid, a polyester diol based on polysuccinic acid, and a polyester diol based on polyadipic acid. In some embodiments, the polyester diol based on polyadipic acid is polyadipic acid-polyneopentyl glycol-polyester diol. In some embodiments, the polyester diol has a number average molecular weight of 1,000 Da to 3,000 Da, and preferably 2,000 Da.

In the present disclosure, in some embodiments, the dihydroxymethyl carboxylic acid includes one or two selected from the group consisting of 2,2-dihydroxymethyl propionic acid and dihydroxymethyl butyric acid.

In the present disclosure, in some embodiments, the diisocyanate includes one or more selected from the group consisting of toluene diisocyanate, isophorone diisocyanate, hexamethylene diisocyanate, ethylphenyl diisocyanate, methylcyclohexyl diisocyanate, and trimethylhexyl diisocyanate.

In the present disclosure, in some embodiments, the catalyst includes one or more of organic bismuth and organic tin. In some embodiments, the organic tin is dibutyltin dilaurate. In some embodiments, the organic bismuth is MC-710 purchased from Beijing Baiyuan Chemical.

In the present disclosure, in some embodiments, the polyether polyol, polyester diol, dihydroxymethyl carboxylic acid, diisocyanate, and catalyst are dried separately before the first mixing.

In the present disclosure, in some embodiments, the first-stage prepolymerization is conducted at a temperature of 70° C. to 90° C., preferably 75° C. to 85° C., and more preferably 77° C. to 80° C. In some embodiments, the first-stage prepolymerization is conducted for 1.5 h to 3 h, preferably 2 h to 2.5 h, and more preferably 2.2 h.

In the present disclosure, in some embodiments, the acetone is added into the first reaction system to adjust the viscosity of the first reaction system to 200 cP to 2,000 cP, preferably 500 cP to 1,500 cP, and more preferably 900 cP to 1,200 cP.

In the present disclosure, in some embodiments, the second-stage prepolymerization is conducted at a temperature of 70° C. to 90° C., preferably 75° C. to 85° C., and more preferably 77° C. to 80° C. In some embodiments, the second-stage prepolymerization is conducted for 1 h to 2 h, preferably 1.2 h to 1.8 h, and more preferably 1.5 h.

In the present disclosure, in some embodiments, the long-chain aliphatic alcohol includes one or more selected from the group consisting of n-hexanol, n-octanol, n-dodecanol, and n-octadecanol.

In the present disclosure, in some embodiments, the end capping is conducted at a temperature of 70° C. to 90° C., preferably 75° C. to 85° C., and more preferably 77° C. to 80° C. In some embodiments, the end capping is conducted for 2 h to 4 h, preferably 3 h to 4 h, and more preferably 3.2 h to 3.6 h.

In the present disclosure, in some embodiments, after the end capping is completed, the method further includes cooling the second PU prepolymer. In some embodiments, the second PU prepolymer is cooled to ambient temperature.

In the present disclosure, in some embodiments, the neutralizer includes one or two selected from the group consisting of triethylamine and triethanolamine.

In the present disclosure, in some embodiments, a ratio of an amount of substance of the dihydroxymethyl carboxylic acid to an amount of substance of the neutralizer is in a range of 1:0.6 to 1:1, preferably 1:0.7 to 1:0.9, and more preferably 1:0.8.

In the present disclosure, in some embodiments, the first stirring is conducted at a speed of 50 rpm to 200 rpm, preferably 90 rpm to 180 rpm, and more preferably 100 rpm to 150 rpm. In some embodiments, the first stirring is conducted for 5 min to 10 min, preferably 6 min to 9 min, and more preferably 7 min to 8 min.

In the present disclosure, in some embodiments, after the second PU prepolymer is obtained, the second PU prepolymer and water are mixed under second stirring for 1 min to 5 min to obtain a mixed system, the water being at a temperature of 2° C. to 10° C. Then, within 1 min to 5 min, an amine chain extender is added into the mixed system, and the mixed system and the amine chain extender are subjected to chain extension reaction under third stirring at ambient temperature for 0.5 h to 2 h. A resulting chain extension reaction product is heated to a temperature of 40° C. to 50° C., and acetone is removed by distillation at the temperature and a pressure of 0.01 MPa to 0.09 MPa to obtain the WPU.

In the present disclosure, in some embodiments, the water is deionized water.

In the present disclosure, in some embodiments, the amine chain extender includes one or more selected from the group consisting of ethylenediamine, propylenediamine, butylenediamine, 2-methylpentanediamine, hexamethylenediamine, isophoronediamine, and sodium 2-[(2-aminoethyl)amino]ethanesulphonate.

In the present disclosure, in some embodiments, the water is added in such amount that the waterborne polyurethane has a solid content of 30 wt % to 50 wt %, preferably 35 wt % to 45 wt %, and more preferably 40 wt %. In some embodiments, the water is at a temperature of 2° C. to 10° C., preferably 4° C. to 8° C., and more preferably 6° C.

In the present disclosure, in some embodiments, a ratio of an amount of substance of a primary amino group in the amine chain extender to the amount of substance of the isocyanate group in the diisocyanate is in a range of 0.2:1 to 0.3:1, preferably 0.22:1 to 0.28:1, and more preferably 0.24:1 to 0.26:1.

In the present disclosure, in some embodiments, a ratio of an amount of substance of a sum of a total hydroxyl group in the polymer polyol, the dihydroxymethyl carboxylic acid, and the long-chain aliphatic alcohol and the primary amino group in the amine chain extender to the amount of substance of the isocyanate group in the diisocyanate is in a range of 0.90:1 to 0.98:1, preferably 0.92:1 to 0.96:1, and more preferably 0.94:1.

In the present disclosure, in some embodiments, the second stirring is conducted at a speed of 200 rpm to 1,000 rpm, preferably 400 rpm to 900 rpm, and more preferably 600 rpm to 800 rpm. In some embodiments, the second stirring is conducted for 1 min to 5 min, preferably 2 min to 4 min, and more preferably 3 min.

In the present disclosure, in some embodiments, the third stirring (chain extension reaction) is conducted at a speed of 50 rpm to 200 rpm, preferably 90 rpm to 180 rpm, and more preferably 100 rpm to 150 rpm. In some embodiments, the third stirring (chain extension reaction) is conducted for 0.5 h to 2 h, preferably 1 h to 1.5 h, and more preferably 1.2 h. In some embodiments, the third stirring (chain extension reaction) is conducted at ambient temperature.

In the present disclosure, in some embodiments, the distillation is conducted at a temperature of 40° C. to 50° C., and preferably 45° C. In some embodiments, the distillation is conducted under a pressure of 0.01 MPa to 0.09 MPa, and preferably 0.02 MPa to 0.06 MPa. In the present disclosure, the acetone is removed by the distillation.

The present disclosure further provides a waterborne scratch-off ink, where the waterborne scratch-off ink is prepared from raw materials including, in percentage by weight:
15% to 35% of a WPU, 0.1% to 1% of a bactericide, 10% to 20% of a filler, 0.1% to 1% of a defoamer, 15% to 50% of a color paste, 2% to 5% of a wax paste, 0.2% to 2% of a rheological agent, 1% to 2% of a film forming auxiliary, and 5% to 25% of water;
where the WPU is the WPU described above or a WPU prepared by the method described above.

In the present disclosure, the raw materials for preparing the waterborne scratch-off ink includes, in percentage by weight, 15% to 35%, preferably 18% to 30%, and more preferably 22% to 27% of the WPU.

In the present disclosure, the raw materials for preparing the waterborne scratch-off ink includes, in percentage by weight, 0.1% to 1%, preferably 0.3% to 0.8%, and more preferably 0.5% to 0.6% of the bactericide. In some embodiments, the bactericide is a Kathon bactericide.

In the present disclosure, the raw materials for preparing the waterborne scratch-off ink includes, in percentage by weight, 10% to 20%, preferably 12% to 18%, and more preferably 14% to 16% of the filler. In some embodiments, the filler includes one or more of precipitated white carbon black, activated calcium carbonate, and silica powder. In some embodiments, the filler has a mesh size of greater than 1,000 mesh, preferably 1,000 mesh to 3,000 mesh, and more preferably 1,500 mesh to 3,000 mesh.

In the present disclosure, the raw materials for preparing the waterborne scratch-off ink includes, in percentage by weight, 0.1% to 1%, preferably 0.3% to 0.8%, and more preferably 0.5% to 0.6% of the defoamer. In some embodiments, the defoamer is Hemmings RHEOLATE299.

In the present disclosure, the raw materials for preparing the waterborne scratch-off ink includes, in percentage by weight, 15% to 50%, preferably 25% to 40%, and more preferably 30% to 35% of the color paste. In some embodiments, the color paste is a white color paste or a black color paste. In some embodiments, the white color paste is an APE-free resin-type aqueous titanium white color paste. In some embodiments, the white color paste has a titanium dioxide content of ≥30%, and preferably 50%. In some embodiments, the white color paste has a fineness of ≤20 μm, and preferably 5 μm to 20 μm. In some embodiments, the black color paste is an APE-free aqueous carbon black color paste or an APE-free aqueous carbon black iron black color paste. In some embodiments, the aqueous carbon black color paste has a carbon black content of ≥10%, and preferably 10% to 20%. In some embodiments, the aqueous carbon black iron black color paste has a carbon black content of ≥5%, and preferably 5% to 8%. In some embodiments, the aqueous carbon black iron black color paste has an iron black content of ≥30%, and preferably 35% to 50%. In some embodiments, the aqueous carbon black iron black color paste has a fineness of ≤20 μm, and preferably 10 μm to 15 μm.

In the present disclosure, in some embodiments, the raw materials for preparing the waterborne scratch-off ink includes, in percentage by weight, 2% to 5%, preferably 3% to 5%, and more preferably 3% to 4% of the wax paste. In some embodiments, the wax paste is an ethylene wax paste or a paraffin wax paste.

In the present disclosure, the raw materials for preparing the waterborne scratch-off ink includes, in percentage by weight, 0.2% to 2%, preferably 0.5% to 1.5%, and more preferably 1% to 1.2% of the rheological agent. In some embodiments, the rheological agent includes one or more of hydroxyethyl cellulose, hydrophobically-modified alkali-swellable acrylic emulsion, and hydrophobically-associated PU emulsion.

In the present disclosure, the raw materials for preparing the waterborne scratch-off ink includes, in percentage by weight, 1% to 2%, preferably 1.2% to 1.8%, and more preferably 1.4% to 1.6% of the film forming auxiliary. In some embodiments, the film forming auxiliary includes one or more of ethylene glycol butyl ether, propylene glycol methyl ether, propylene glycol butyl ether, and alcohol ester-12.

In the present disclosure, the raw materials for preparing the waterborne scratch-off ink includes, in percentage by weight, 5% to 25%, preferably 10% to 20%, and more preferably 15% of the water. In some embodiments, the water is deionized water.

The present disclosure further provides a method for preparing the waterborne scratch-off ink, including the following steps:
subjecting the waterborne polyurethane, the bactericide, the filler, and the defoamer to high-speed premixing;
subjecting a resulting premixture and the color paste to first low-speed mixing to obtain a colored mixture;
subjecting the colored mixture and the wax paste, the rheological agent, the film forming auxiliary, and the water to second low-speed mixing, and regulating a pH value of a resulting mixed solution to 6 to 9 by using a pH regulator to obtain the waterborne scratch-off ink;
where the high-speed premixing is conducted at a speed of 200 rpm to 1,000 rpm; the first low-speed mixing is conducted at a speed of 50 rpm to 200 rpm; and the second low-speed mixing is conducted at a speed of 50 rpm to 200 rpm.

In the present disclosure, the high-speed premixing is conducted at a speed of 200 rpm to 1,000 rpm, preferably 400 rpm to 900 rpm, more preferably 600 rpm to 800 rpm. In some embodiments, the high-speed premixing is conducted for 30 min to 40 min, and preferably 34 min to 37 min.

In the present disclosure, the first low-speed mixing is conducted at a speed of 50 rpm to 200 rpm, preferably 70 rpm to 150 rpm, and more preferably 90 rpm to 120 rpm. In some embodiments, the first low-speed mixing is conducted for 1 h to 3 h, and preferably 1.5 h to 2.5 h.

In the present disclosure, the second low-speed mixing is conducted at a speed of 50 rpm to 200 rpm, preferably 70 rpm to 150 rpm, and more preferably 90 rpm to 120 rpm. In some embodiments, the second low-speed mixing is conducted for 1 h to 3 h, and preferably 1.5 h to 2.5 h.

In the present disclosure, in some embodiments, the pH regulator includes one or more of sodium dihydrogen phosphate, sodium bicarbonate, sodium carbonate, and sodium phosphate.

In the present disclosure, in some embodiments, after the pH value of the resulting mixed solution is regulated to 6 to 9, a resulting product system is defoamed, and then, a resulting defoamed system is regulated to have a viscosity of 100 cP to 300 cP by adding water, and then a resulting system is filtered. In some embodiments, the defoaming is static defoaming. In some embodiments, the resulting defoamed system is regulated to have a viscosity of 100 cP to 300 cP by adding water, preferably 150 cP to 250 cP, and more preferably 180 cP to 220 cP. In some embodiments, the filtration is conducted at a pore size of 80 mesh to 200 mesh, and preferably 100 mesh.

In order to further illustrate the present disclosure, the technical solutions of the present disclosure are described in detail below in connection with accompanying examples, but these examples should not be understood as a limit to the scope of the present disclosure.

In specific examples of the present disclosure, the polyether diol is DL2000 purchased from Bluestar Dongda, Shandong, China; the polyether triol is 330N purchased from Bluestar Dongda, Shandong, China; the polyester diol is PE-5556 purchased from Jiangsu Huafeng, Jiangsu, China; and the organic bismuth catalyst is MC-710 purchased from Beijing Baiyuan Chemical, Beijing, China.

### Example 1

3,000 g of dried polyether diol (DL2000, number average molecular weight 2,000 Da, Bluestar Dongda, Shandong, China), 600 g of polyether triol (330N, number average molecular weight 3,000 Da, Bluestar Dongda, Shandong, China), 1,000 g of polyester diol (PE-5556, number average molecular weight 2,000 Da, Jiangsu Huafeng, China), 1,112 g of isophorone diisocyanate, 201 g of dihydroxymethyl carboxylic acid, and 0.50 g of an organic bismuth catalyst (MC-710, Beijing Baiyuan Chemical, China) were added into a reactor, stirred evenly, heated to 80° C. and reacted for 2 h to obtain a reaction system. 600 g of acetone was added thereto to adjust a viscosity of the reaction system to 200 cP. A resulting system was reacted continuously for 2 h. 130 g of n-octanol was added thereto, and then, a resulting system was reacted continuously for 3 h. A resulting reaction product was cooled to ambient temperature, 150 g of triethylamine was added thereto, and a resulting mixture was stirred at 50 rpm for 5 min until uniformly mixed to obtain a second PU prepolymer.

11,580 g of 2° C. pure water was quickly added into the second PU prepolymer, and stirred at 1,000 rpm for 3 min. Under the stirring, 200 g of a 50% aqueous solution of ethylenediamine was added dropwise within 2 min, and then, a resulting mixture was stirred at 50 rpm for 1 h. Then, the resulting mixture was subjected to distillation under 0.02 MPa at 40° C. to remove acetone to obtain a WPU.

### Example 2

3,000 g of dried polyether diol (DL2000, number average molecular weight 2,000 Da, Bluestar Dongda, Shandong, China), 600 g of polyether triol (330N, number average molecular weight 3,000 Da, Bluestar Dongda, Shandong, China), 1,000 g of polyester diol (PE-5556, number average molecular weight 2,000 Da, Jiangsu Huafeng, China), 889 g of isophorone diisocyanate, 174 g of toluene diisocyanate, 201 g of dihydroxymethyl carboxylic acid, and 0.50 g of dibutyltin dilaurate were added into a reactor, stirred evenly, heated to 75° C. and reacted for 1.5 h to obtain a reaction system. 600 g of acetone was added thereto to adjust a viscosity of the reaction system to 2,000 cP. A resulting system was reacted continuously for 2 h. 130 g of n-octanol was added thereto, and then, a resulting system was reacted continuously for 3 h. A resulting reaction product was cooled to ambient temperature, 150 g of triethylamine was added thereto, and a resulting mixture was stirred at 200 rpm for 5 min until uniformly mixed to obtain a second PU prepolymer.

11,470 g of 10° C. pure water was quickly added into the second PU prepolymer, and stirred at 1,000 rpm for 5 min. Under the stirring, 140 g of a 50% aqueous solution of ethylenediamine was added dropwise within 5 min, and then, a resulting mixture was stirred at 200 rpm for 1 h. Then, the resulting mixture was subjected to distillation under 0.05 MPa at 50° C. to remove acetone to obtain a WPU.

### Example 3

3,000 g of dried polyether diol (DL2000, number average molecular weight 2,000 Da, Bluestar Dongda, Shandong, China), 600 g of polyether triol (330N, number average molecular weight 3,000 Da, Bluestar Dongda, Shandong, China), 1,000 g of polyester diol (PE-5556, number average molecular weight 2,000 Da, Jiangsu Huafeng, China), 672 g of hexamethylene diisocyanate, 174 g of toluene diisocyanate, 201 g of dihydroxymethyl carboxylic acid, and 0.50 g of dibutyltin dilaurate were added into a reactor, stirred evenly, heated to 75° C. and reacted for 1.5 h to obtain a reaction system. 600 g of acetone was added thereto to adjust a viscosity of the reaction system to 1,000 cP. A resulting system was reacted continuously for 2 h. 186 g of n-dodecanol was added thereto, and then, a resulting system was reacted continuously for 4 h. A resulting reaction product was cooled to ambient temperature, 220 g of triethanolamine was added thereto, and a resulting mixture was stirred at 100 rpm for 5 min until uniformly mixed to obtain a second PU prepolymer.

11,320 g of 5° C. pure water was quickly added into the second PU prepolymer, and stirred at 500 rpm for 3 min. Under the stirring, 200 g of a 50% aqueous solution of ethylenediamine was added dropwise within 3 min, and then, a resulting mixture was stirred at 100 rpm for 1 h. Then, the resulting mixture was subjected to distillation under 0.04 MPa at 45° C. to remove acetone to obtain a WPU.

### Example 4

2,000 g of dried polyether diol (DL2000, number average molecular weight 2,000 Da, Bluestar Dongda, Shandong, China), 400 g of polyether triol (330N, number average molecular weight 3,000 Da, Bluestar Dongda, Shandong, China), 2,000 g of polyester diol (PE-5556, number average molecular weight 2,000 Da, Jiangsu Huafeng, China), 1,112 g of isophorone diisocyanate, 201 g of dihydroxymethyl carboxylic acid, and 0.50 g of an organic bismuth catalyst (MC-710, Beijing Baiyuan Chemical, China) were added into a reactor, stirred evenly, heated to 75° C. and reacted for 2 h to obtain a reaction system. 600 g of acetone was added thereto to adjust a viscosity of the reaction system to 1,500 cP. A resulting system was reacted continuously for 2 h. 130 g of n-octanol was added thereto, and then, a resulting system was reacted continuously for 3 h. A resulting reaction product was cooled to ambient temperature, 150 g of triethylamine was added thereto, and a resulting mixture was stirred at 150 rpm for 5 min until uniformly mixed to obtain a second PU prepolymer.

11,220 g of 7° C. pure water was quickly added into the second PU prepolymer, and stirred at 200 rpm for 4 min. Under the stirring, 220 g of a 50% aqueous solution of ethylenediamine was added dropwise within 4 min, and then, a resulting mixture was stirred at 150 rpm for 1 h. Then, the resulting mixture was subjected to distillation under 0.05 MPa at 50° C. to remove acetone to obtain a WPU.

### Example 5

3,000 g of dried polyether diol (DL2000, number average molecular weight 2,000 Da, Bluestar Dongda, Shandong, China), 600 g of polyether triol (330N, number average molecular weight 3,000 Da, Bluestar Dongda, Shandong, China), 1,000 g of polyester diol (PE-5556, number average molecular weight 2,000 Da, Jiangsu Huafeng, China), 1, 112 g of isophorone diisocyanate, 201 g of dihydroxymethyl carboxylic acid, and 0.50 g of an organic bismuth catalyst (MC-710, Beijing Baiyuan Chemical, China) were added into a reactor, stirred evenly, heated to 75° C. and reacted for 2 h to obtain a reaction system. 600 g of acetone was added thereto to adjust a viscosity of the reaction system to 1,000 cP. A resulting system was reacted continuously for 2 h. 51 g of n-hexanol and 135 g of n-octadecanol were added thereto, and then, a resulting system was reacted continuously for 4 h. A resulting reaction product was cooled to ambient temperature, 150 g of triethylamine was added thereto, and a resulting mixture was stirred at 180 rpm for 5 min until uniformly mixed to obtain a second PU prepolymer.

11,690 g of 4° C. pure water was quickly added into the second PU prepolymer, and stirred at 700 rpm for 3 min. Under the stirring, 200 g of a 50% aqueous solution of ethylenediamine was added dropwise within 4 min, and then, a resulting mixture was stirred at 120 rpm for 1 h. Then, the resulting mixture was subjected to distillation under 0.03 MPa at 42° C. to remove acetone to obtain a WPU.

### Example 6

2,000 g of dried polyether diol (DL2000, number average molecular weight 2,000 Da, Bluestar Dongda, Shandong, China), 400 g of polyether triol (330N, number average molecular weight 3,000 Da, Bluestar Dongda, Shandong, China), 2,000 g of polyester diol (PE-5556, number average molecular weight 2,000 Da, Jiangsu Huafeng, China), 1,112 g of isophorone diisocyanate, 201 g of dihydroxymethyl carboxylic acid, and 0.50 g of dibutyltin dilaurate were added into a reactor, stirred evenly, heated to 75° C. and reacted for 2 h to obtain a reaction system. 600 g of acetone was added thereto to adjust a viscosity of the reaction system to 400 cP. A resulting system was reacted continuously for 2 h. 65 g of n-octanol and 93 g of n-dodecanol were added thereto, and then, a resulting system was reacted continuously for 3 h. A resulting reaction product was cooled to ambient temperature, 150 g of triethylamine was added thereto, and a resulting mixture was stirred at 80 rpm for 5 min until uniformly mixed to obtain a second PU prepolymer.

11,270 g of 9° C. pure water was quickly added into the second PU prepolymer, and stirred at 300 rpm for 2 min. Under the stirring, 220 g of a 50% aqueous solution of ethylenediamine was added dropwise within 3 min, and then, a resulting mixture was stirred at 170 rpm for 1 h. Then, the resulting mixture was subjected to distillation under 0.03 MPa at 47° C. to remove acetone to obtain a WPU.

### Comparative Example 1

3,000 g of dried polyether diol (DL2000, number average molecular weight 2,000 Da, Bluestar Dongda, Shandong, China), 600 g of polyether triol (330N, number average molecular weight 3,000 Da, Bluestar Dongda, Shandong, China), 1,000 g of polyester diol (PE-5556, number average molecular weight 2,000 Da, Jiangsu Huafeng, China), 1,112 g of isophorone diisocyanate, 201 g of dihydroxymethyl carboxylic acid, and 0.50 g of an organic bismuth catalyst (MC-710, Beijing Baiyuan Chemical, China) were added into a reactor, stirred evenly, heated to 80° C. and reacted for 2 h to obtain a reaction system. 600 g of acetone was added thereto to adjust a viscosity of the reaction system to 200 cP. A resulting system was reacted continuously for 3 h to obtain a reaction product. The reaction product was cooled to ambient temperature, 150 g of triethylamine was added thereto, and a resulting mixture was stirred at 50 rpm for 5 min until uniformly mixed to obtain a second PU prepolymer.

11,370 g of 2° C. pure water was quickly added into the second PU prepolymer, and stirred at 1,000 rpm for 3 min. Under the stirring, 260 g of a 50% aqueous solution of ethylenediamine was added dropwise within 2 min, and then, a resulting mixture was stirred at 50 rpm for 1 h. Then, a resulting mixture was subjected to distillation under 0.02 MPa at 40° C. to remove acetone to obtain a WPU.

### Example 7

According to the weight ratio of formula, deionized water and a co-solvent were added into a dispersion kettle. Then, 1,500 g of the WPU synthesized in Example 1, 8 g of a bactericide, 1,000 g of 2,000 mesh precipitated white carbon black, and 8 g of an AFE-3168 defoamer were added thereto. A resulting mixture was dispersed at a high speed for 40 min, and then, 1,500 g of a titanium dioxide white color paste was added under low-speed stirring. After stirring evenly, 100 g of a wax paste, 3 g of sodium carbonate, 15 g of Hemmings RHEOLATE299 rheological agent, 80 g of propylene glycol methyl ether, and 240 g of deionized water were added thereto. A resulting mixture was stirred and defoamed. Then, a resulting defoamed mixture was adjusted to have a viscosity of 250 cP by using water, and then a resulting material was filtered and packaged to obtain a white waterborne scratch-off ink.

### Example 8

According to the weight ratio of formula, deionized water and a co-solvent were added into a dispersion kettle. Then, 1,500 g of the WPU synthesized in Example 1, 8 g of a bactericide, 800 g of 2,000 mesh precipitated white carbon black, 300 g of activated calcium carbonate, and 8 g of an AFE-3168 defoamer were added thereto. A resulting mixture was dispersed at a high speed for 30 min, and then, 1,200 g of a carbon black color paste was added under low-speed stirring. After stirring evenly, 100 g of a wax paste, 3 g of sodium carbonate, 15 g of Hemmings RHEOLATE299 rheological agent, 80 g of propylene glycol methyl ether, and 240 g of deionized water were added thereto. A resulting mixture was stirred and defoamed. Then, a resulting defoamed mixture was adjusted to have a viscosity of 150 cP by using water, and then a resulting material was filtered and packaged to obtain a black waterborne scratch-off ink.

### Example 9

According to the weight ratio of formula, deionized water and a co-solvent were added into a dispersion kettle. Then, 1,500 g of the WPU synthesized in Example 4, 8 g of a bactericide, 1,000 g of 2,000 mesh precipitated white carbon black, 300 g of a silica powder, and 8 g of an AFE-3168 defoamer were added thereto. A resulting mixture was dispersed at a high speed for 35 min, and then, 1,500 g of a titanium dioxide white color paste was added under low-speed stirring. After stirring evenly, 100 g of a wax paste, 3 g of sodium carbonate, 15 g of Hemmings RHEOLATE299 rheological agent, 80 g of propylene glycol methyl ether, and 240 g of deionized water were added thereto. A resulting mixture was stirred and defoamed. Then, a resulting defoamed mixture was adjusted to have a viscosity of 200 cP by using water, and then a resulting material was filtered and packaged to obtain a white waterborne scratch-off ink.

### Example 10

According to the weight ratio of formula, deionized water and a co-solvent were added into a dispersion kettle. Then, 1,500 g of the WPU synthesized in Example 5, 8 g of a bactericide, 1,000 g of 2,000 mesh precipitated white carbon black, 200 g of activated calcium carbonate, and 8 g of an AFE-3168 defoamer were added thereto. A resulting mixture was dispersed at a high speed for 32 min, and then, 1,500 g of a carbon black color paste was added under low-speed stirring. After stirring evenly, 100 g of a wax paste, 3 g of sodium carbonate, 15 g of Hemmings RHEOLATE299 rheological agent, 80 g of propylene glycol methyl ether, and 240 g of deionized water were added thereto. A resulting mixture was stirred and defoamed. Then, a resulting defoamed mixture was adjusted to have a viscosity of 100 cP by using water, and then a resulting material was filtered and packaged to obtain a black waterborne scratch-off ink.

### Comparative Example 2

According to the weight ratio of formula, deionized water and a co-solvent were added into a dispersion kettle. Then, 1,500 g of the WPU synthesized in Comparative Example 1, 8 g of a bactericide, 1,000 g of 2,000 mesh precipitated white carbon black, and 8 g of an AFE-3168 defoamer were added thereto. A resulting mixture was dispersed at a high speed for 40 min, and then, 1,500 g of a titanium dioxide white color paste was added under low-speed stirring. After stirring evenly, 100 g of a wax paste, 3 g of sodium carbonate, 15 g of Hemmings RHEOLATE299 rheological agent, 80 g of propylene glycol methyl ether, and 240 g of deionized water were added thereto. A resulting mixture was stirred and defoamed. Then, a resulting defoamed mixture was adjusted to have a viscosity of 250 cP by using water, and then a resulting material was filtered and packaged to obtain a white waterborne scratch-off ink.

The parameters of the WPU samples prepared in Examples 1 to 6 were tested, where in Examples 1 to 6, polyester diol, polyether diol, diisocyanate, and different long-chain aliphatic alcohols were used to prepare WPU. Comparative Example 1 was conducted according to the method of Example 1, except that long-chain aliphatic alcohol was not used.

Appearance, solid content, and viscosity were tested in accordance with GB/T 11175-2021. Viscosity test instrument: Brookfield viscometer DVI, determination method: direct test at 25° C. VOCs: tested in accordance with GB/T 23986-2009. pH value is determined using a Mettler Toledo LP115 pH meter. Test method for 100% modulus and elongation at break: a certain amount of WPU was placed in a polytetrafluoroethylene mold, left standing for 1 day to 2 days, dried naturally, and then tested for the 100% modulus and elongation at break by using a Shanghai Songdun WDW-5 universal material testing machine. The results are shown in Table 1.

TABLE 1
WPU samples prepared in Examples 1 to 6 and dry film parameters thereof

| | | | Viscosity | | 100% | 100% |
|---|---|---|---|---|---|---|
| | Solid | | at 25° | | modulus/ | elongation |
| PU | content | Appearance | C./mPa · s | pH | MPa | at break |
| Example 1 | 35% | Aqueous white | 60 | 8.1 | 1.5 | 700 |
| | | dispersion | | | | |
| Example 2 | 35% | Aqueous white | 62 | 8.2 | 1.5 | 800 |
| | | dispersion | | | | |
| Example 3 | 35% | Aqueous white | 58 | 8.0 | 1.6 | 700 |
| | | dispersion | | | | |
| Example 4 | 35% | Aqueous white | 60 | 8.1 | 1.5 | 800 |
| | | dispersion | | | | |
| Example 5 | 35% | Aqueous white | 61 | 8.2 | 1.4 | 800 |
| | | dispersion | | | | |
| Example 6 | 35% | Aqueous white | 62 | 8.0 | 1.5 | 700 |
| | | dispersion | | | | |
| Comparative | 35% | Aqueous white | 55 | 8.0 | 1.8 | 900 |
| Example 1 | | dispersion | | | | |

According to Table 1, Examples 1 to 6 and Comparative Example 1 all prepared WPU, and the solid content, appearance, viscosity, and pH value of the WPU are similar. Compared with Comparative Example 1, the 100% modulus and elongation at break of the dry films of WPU samples of Examples 1 to 6 are slightly lower. The lower modulus of the dry film of WPU samples in Examples 1 to 6 is due to the monofunctional long-chain aliphatic alcohol end capping of the PU prepolymer and the lower PU molecular weight. In addition, the microphase separation caused by the long-chain alkyl group also reduces the mechanical properties of the dry film of WPU samples, achieving the easy scratching off of waterborne scratch-off ink.

According to relevant national standards, the performance of the waterborne scratch-off inks of Examples 7 to 10 and Comparative Example 2 was tested, and the test results are shown in Table 2.

TABLE 2
Parameters of waterborne scratch-off inks of
Examples 7 to 10 and Comparative Example 2

| | Example | Example | Example | Example | Comparative | |
|---|---|---|---|---|---|---|
| Scratch-off ink | 7 | 8 | 9 | 10 | Example 2 | Remarks |
| Appearance | White | Black | White | Black | White | — |
| Fineness/μm | ≤20 | ≤20 | ≤20 | ≤20 | ≤20 | — |
| VOC/% | 2 | 2 | 2 | 2 | 2 | — |
| Surface drying | ≤20 | ≤20 | ≤20 | ≤20 | ≤20 | Ambient |
| time/min | | | | | | temperature |
| Hard drying | ≤80 | ≤80 | ≤80 | ≤80 | ≤80 | Ambient |
| time/min | | | | | | temperature |
| Scratch-off | 10 | 9 | 10 | 10 | 2 | — |
| degree/g | | | | | | |
| Scratch-off | 9 | 9 | 9 | 9 | 2 | Immersing |
| degree after | | | | | | in water at |
| aging/g | | | | | | ambient |
| | | | | | | temperature |
| | | | | | | for 48 h |
| Scratch-off | 9 | 9 | 9 | 9 | 2 | Standing at |
| degree after | | | | | | 50° C., |
| aging/g | | | | | | 80% humidity |
| | | | | | | for 48 h |

According to Table 2, the white waterborne scratch-off ink and black waterborne scratch-off ink prepared with the WPU of Examples 1, 4, and 5, namely Examples 7 to 10, all have desirable fineness and a short surface drying time, and have a VOC content of as low as 2%. Compared with Comparative Example 2, the while waterborne scratch-off ink and black waterborne scratch-off ink of Examples 7 to 10 show obvious easy scratching off properties; and under different aging conditions, the scratchability of the while waterborne scratch-off ink and black waterborne scratch-off ink remains unchanged or basically unchanged.

It can be seen from the above examples that the WPU provided by the present disclosure can be used to prepare waterborne scratch-off ink, the dosage of organic solvent used in the waterborne scratch-off ink is less than 2 wt %, the ink has excellent scratchability, and the scratchability remains stable under aging conditions.

Although the present disclosure is described in detail in conjunction with the foregoing examples, they are only a part of, not all of, the examples of the present disclosure. Other examples can be obtained based on these examples without creative efforts, and all of these examples shall fall within the scope of the present disclosure.

What is claimed is:

1. A waterborne polyurethane, having a structure shown in formula I: 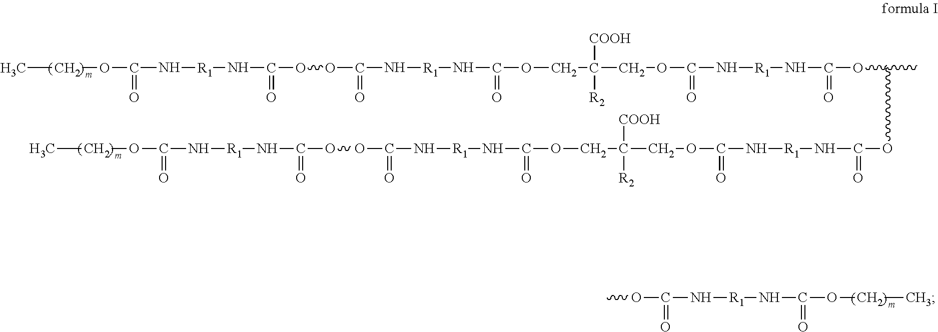
wherein in formula I,
R₁ is selected from the group consisting of alkylene, cycloalkylene, and aralkylene;
R₂ is selected from the group consisting of alkyl, cycloalkyl, and aralkyl;
m is a natural number greater than or equal to 5; and
wavy lines “ [symbol] ” represent a number of repeating units, and each of the repeating units has a structure shown in formula II:

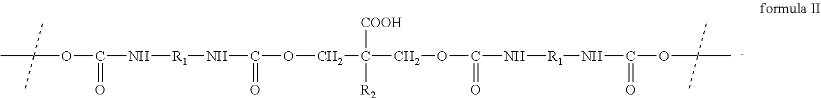

2. The waterborne polyurethane of claim 1, wherein in R₁, the alkylene comprises one selected from the group consisting of C₁ alkylene to C₆ alkylene; the cycloalkylene comprises one selected from the group consisting of C₅ cycloalkylene to C₁₅ cycloalkylene; and the aralkylene comprises one selected from the group consisting of C₆ aralkylene to C₁₅ aralkylene; and
in R₂, the alkyl comprises one selected from the group consisting of C₁ alkyl to C₆ alkyl; the cycloalkyl comprises one selected from the group consisting of C₅ cycloalkyl to C₁₅ cycloalkyl; and the aralkyl comprises one selected from the group consisting of C₆ aralkyl to C₁₅ aralkyl.

3. A method for preparing the waterborne polyurethane of claim 1, comprising:
(1) mixing a polymer polyol, a dihydroxymethyl carboxylic acid, a diisocyanate, and a catalyst to obtain a mixture; and subjecting the mixture to first-stage prepolymerization to obtain a first reaction system;
adding acetone into the first reaction system to adjust a viscosity of the first reaction system to 200 cP to 2,000 cP, and subjecting a resulting system to second-stage prepolymerization to obtain a first polyurethane prepolymer;
mixing the first polyurethane prepolymer and a long-chain aliphatic alcohol to obtain an admixture; and subjecting the admixture to end capping to obtain an end capping product; and
mixing the end capping product and a neutralizer under first stirring for 5 min to 10 min to obtain a second polyurethane prepolymer; wherein
the polymer polyol comprises one or more selected from the group consisting of a polyether polyol and a polyester diol;
the dihydroxymethyl carboxylic acid has a structural formula of (CH₂OH)₂—C(R₂)—COOH;
the diisocyanate has a structural formula of NCO—R₁—NCO; and
the long-chain aliphatic alcohol has a structural formula of CH₃—(CH₂)ₘ—OH; and
(2) mixing the second polyurethane prepolymer and water under second stirring for 1 min to 5 min to obtain a mixed system, the water being at a temperature of 2° C. to 10° C.;
adding an amine chain extender into the mixed system within 1 min to 5 min, and subjecting the mixed system and the amine chain extender to chain extension reaction under third stirring at ambient temperature for 0.5 h to 2 h; and
heating a resulting chain extension reaction product to a temperature of 40° C. to 50° C., and removing the acetone by distillation at the temperature and a pressure of 0.01 MPa to 0.09 MPa to obtain the waterborne polyurethane; wherein
the amine chain extender comprises at least one primary amino group; and the second stirring is conducted at a speed of 200 rpm to 1,000 rpm.

4. The method of claim 3, wherein the first-stage prepolymerization is conducted at a temperature of 70° C. to 90° C. for 1.5 h to 3 h;
the second-stage prepolymerization is conducted at a temperature of 70° C. to 90° C. for 1 h to 2 h; and
the end capping is conducted at a temperature of 70° C. to 90° C. for 2 h to 4 h.

5. The method of claim 3, wherein a ratio of an amount of substance of a hydroxyl group in the polymer polyol to an amount of substance of an isocyanate group in the diisocyanate is in a range of 0.1:1 to 0.3:1;
a ratio of an amount of substance of a hydroxyl group in the dihydroxymethyl carboxylic acid to the amount of substance of the isocyanate group in the diisocyanate is in a range of 0.2:1 to 0.3:1;
a ratio of an amount of substance of the long-chain aliphatic alcohol to the amount of substance of the isocyanate group in the diisocyanate is in a range of 0.2:1 to 0.3:1;
a ratio of an amount of substance of a primary amino group in the amine chain extender to the amount of substance of the isocyanate group in the diisocyanate is in a range of 0.2:1 to 0.3:1;
a ratio of an amount of substance of a sum of a total hydroxyl group in the polymer polyol, the dihydroxymethyl carboxylic acid, and the long-chain aliphatic alcohol and the primary amino group in the amine chain extender to the amount of substance of the isocyanate group in the diisocyanate is in a range of 0.90:1 to 0.98:1; and
a ratio of an amount of substance of the dihydroxymethyl carboxylic acid to an amount of substance of the neutralizer is in a range of 1:0.6 to 1:1.

6. The method of claim 3, wherein the water is added in such amount that the waterborne polyurethane has a solid content of 30 wt % to 50 wt %.

7. The method of claim 3, wherein the polyether polyol comprises a polyether diol and a polyether triol; the polyether diol accounts for 80 wt % to 90 wt %, and the polyether triol accounts for 10 wt % to 20 wt %;
the polyester diol comprises one or more selected from the group consisting of a polyester diol based on polyoxalic acid, a polyester diol based on polysuccinic acid, and a polyester diol based on polyadipic acid;
the dihydroxymethyl carboxylic acid comprises one or two selected from the group consisting of 2,2-dihydroxymethyl propionic acid and dihydroxymethyl butyric acid;
the diisocyanate comprises one or more selected from the group consisting of toluene diisocyanate, isophorone diisocyanate, hexamethylene diisocyanate, ethylphenyl diisocyanate, methylcyclohexyl diisocyanate, and trimethylhexyl diisocyanate;
the catalyst comprises one or more selected from the group consisting of organic bismuth and organic tin;
the long-chain aliphatic alcohol comprises one or more selected from the group consisting of n-hexanol, n-octanol, n-dodecanol, and n-octadecanol; and
the neutralizer comprises one or two selected from the group consisting of triethylamine and triethanolamine.

8. The method of claim 3, wherein the amine chain extender comprises one or more selected from the group consisting of ethylenediamine, propylenediamine, butylenediamine, 2-methylpentanediamine, hexamethylenediamine, isophoronediamine, and sodium 2-[(2-aminoethyl)amino]ethanesulphonate.

9. The method of claim 3, wherein in R₁, the alkylene comprises one selected from the group consisting of C₁ alkylene to C₆ alkylene; the cycloalkylene comprises one selected from the group consisting of C₅ cycloalkylene to C₁₅ cycloalkylene; and the aralkylene comprises one selected from the group consisting of C₆ aralkylene to C₁₅ aralkylene; and
in R₂, the alkyl comprises one selected from the group consisting of C₁ alkyl to C₆ alkyl; the cycloalkyl comprises one selected from the group consisting of C₅ cycloalkyl to C₁₅ cycloalkyl;
and the aralkyl comprises one selected from the group consisting of C₆ aralkyl to C₁₅ aralkyl.

10. The method of claim 5, wherein the polyether polyol comprises a polyether diol and a polyether triol; the polyether diol accounts for 80 wt % to 90 wt %, and the polyether triol accounts for 10 wt % to 20 wt %;
the polyester diol comprises one or more selected from the group consisting of a polyester diol based on polyoxalic acid, a polyester diol based on polysuccinic acid, and a polyester diol based on polyadipic acid;
the dihydroxymethyl carboxylic acid comprises one or two selected from the group consisting of 2,2-dihydroxymethyl propionic acid and dihydroxymethyl butyric acid;
the diisocyanate comprises one or more selected from the group consisting of toluene diisocyanate, isophorone diisocyanate, hexamethylene diisocyanate, ethylphenyl diisocyanate, methylcyclohexyl diisocyanate, and trimethylhexyl diisocyanate;
the catalyst comprises one or more selected from the group consisting of organic bismuth and organic tin;
the long-chain aliphatic alcohol comprises one or more selected from the group consisting of n-hexanol, n-octanol, n-dodecanol, and n-octadecanol; and
the neutralizer comprises one or two selected from the group consisting of triethylamine and triethanolamine.

11. The method of claim 6, wherein the amine chain extender comprises one or more selected from the group consisting of ethylenediamine, propylenediamine, butylenediamine, 2-methylpentanediamine, hexamethylenediamine, isophoronediamine, and sodium 2-[(2-aminoethyl)amino]ethanesulphonate.

12. A waterborne scratch-off ink, being prepared from raw materials comprising, in percentage by weight:
15% to 35% of a waterborne polyurethane, 0.1% to 1% of a bactericide, 10% to 20% of a filler, 0.1% to 1% of a defoamer, 15% to 50% of a color paste, 2% to 5% of a wax paste, 0.2% to 2% of a rheological agent, 1% to 2% of a film forming auxiliary, and 5% to 25% of water;
wherein the waterborne polyurethane is the waterborne polyurethane of claim 1.

13. The waterborne scratch-off ink of claim 12, wherein in R₁, the alkylene comprises one selected from the group consisting of C₁ alkylene to C₆ alkylene; the cycloalkylene comprises one selected from the group consisting of C₅ cycloalkylene to C₁₅ cycloalkylene; and the aralkylene comprises one selected from the group consisting of C₆ aralkylene to C₁₅ aralkylene; and
in R₂, the alkyl comprises one selected from the group consisting of C₁ alkyl to C₆ alkyl; the cycloalkyl comprises one selected from the group consisting of C₅ cycloalkyl to C₁₅ cycloalkyl; and the aralkyl comprises one selected from the group consisting of C₆ aralkyl to C₁₅ aralkyl.

14. A waterborne scratch-off ink, being prepared from raw materials comprising, in percentage by weight:
15% to 35% of a waterborne polyurethane, 0.1% to 1% of a bactericide, 10% to 20% of a filler, 0.1% to 1% of a defoamer, 15% to 50% of a color paste, 2% to 5% of a wax paste, 0.2% to 2% of a rheological agent, 1% to 2% of a film forming auxiliary, and 5% to 25% of water;
wherein the waterborne polyurethane is prepared by the method of claim 3.

15. A method for preparing the waterborne scratch-off ink of claim 12, comprising:
subjecting the waterborne polyurethane, the bactericide, the filler, and the defoamer to high-speed premixing;
subjecting a resulting premixture and the color paste to first low-speed mixing to obtain a colored mixture;
subjecting the colored mixture and the wax paste, the rheological agent, the film forming auxiliary, and the water to second low-speed mixing, and
regulating a pH value of a resulting mixed solution to 6 to 9 by using a pH regulator to obtain the waterborne scratch-off ink;
wherein the high-speed premixing is conducted at a speed of 200 rpm to 1,000 rpm; the first low-speed mixing is conducted at a speed of 50 rpm to 200 rpm; and the second low-speed mixing is conducted at a speed of 50 rpm to 200 rpm.
